(19) United States
(12) Patent Application Publication
(10) Pub. No.: US 2023/0198041 A1
(43) Pub. Date: Jun. 22, 2023

(54) OPENING AN END-OF-LIFE BATTERY

(71) Applicant: HULICO LLC, Bend, OR (US)

(72) Inventors: Steven E. Sloop, Bend, OR (US); Lauren E. Crandon, Bend, OR (US)

(21) Appl. No.: 18/145,202

(22) Filed: Dec. 22, 2022

Related U.S. Application Data
(60) Provisional application No. 63/265,886, filed on Dec. 22, 2021.

(51) Int. Cl. H01M 10/54; B24C 1/04; B24C 11/00

(52) U.S. Cl. CPC H01M 10/54; B24C 1/045; B24C 11/00

(57) ABSTRACT

Examples are disclosed that relate to opening lithium-ion batteries in an end-of-life process using a fluid cutting apparatus. One example provides a method of opening a battery in an end-of-life process where the battery comprises a plurality of electrode layers. The method comprises placing the battery in a fluid cutting apparatus, and forming a stream of a cutting fluid. The method further comprises impinging the stream of the cutting fluid onto the battery at a sufficient pressure to form a cut entirely through all layers of the battery, wherein the cutting fluid forms a passivating layer at an interface formed by the cut by reacting with one or more electrode materials within the battery.

### CROSS-REFERENCE TO RELATED APPLICATION

This application claims priority to U.S. provisional application No. 63/265,886 entitled OPENING AN END-OF-LIFE BATTERY, filed Dec. 22, 2021, the entire contents of which are hereby incorporated by reference for all purposes.

### BACKGROUND

Rechargeable batteries, such as lithium-ion batteries, provide power to products ranging from automobiles to smart phones. These batteries may be rechargeable over many cycles, tolerant to various environmental factors, and have a relatively long useful lifetime. Nevertheless, they eventually fail or are discarded prior to failure, and therefore contribute to a significant waste stream. Thus, environmental regulations, industry standards, and collection services have arisen to promote the recycling of lithium-ion batteries.

### SUMMARY

Examples are disclosed that relate to opening lithium-ion batteries in an end-of-life process using a fluid cutting apparatus. One example comprises placing a battery in a fluid cutting apparatus, and forming a stream of a cutting fluid. The method further comprises impinging the stream of the cutting fluid onto the battery at a sufficient pressure to form a cut entirely through all layers of the battery, wherein the cutting fluid forms a passivating layer at an interface formed by the cut by reacting with one or more electrode materials within the battery.

### BRIEF DESCRIPTION OF THE DRAWINGS

FIG. 1 shows a schematic diagram of an example fluid cutting apparatus.

FIG. 2 shows a schematic depiction of an example cutline on an example battery cell.

FIG. 3 shows a schematic depiction of another example cutline on another example battery cell.

FIG. 4A and FIG. 4B show a flow diagram depicting an example method of opening a battery in an end-of-life process.

FIG. 5 shows a flow diagram depicting an example method for recovering lithium from a battery in an end-of-life process.

FIG. 6 shows an example lithium-ion battery comprising a graphitic anode that has been cut using the fluid cutting apparatus of FIG. 1 and positioned within a splashing range of a cutting bath.

FIG. 7 shows an example lithium-ion battery comprising a graphitic anode that has been cut using the fluid cutting apparatus of FIG. 1 and positioned above a splashing range of a cutting bath.

### DETAILED DESCRIPTION

The recycling of batteries, including rechargeable batteries such as lithium-ion batteries, as well also non-rechargeable batteries, poses various challenges. For example, disassembling batteries to recover electrode materials can be difficult to perform in a safe and efficient manner. Many batteries comprise a cannister or pouch that encloses one or more layers of electrode/separator stacks, where each electrode/separator stack comprises cathode, separator/electrolyte, and anode layers. The cathode and anode layers each comprises a respective electrode material arranged on a current collector. Example cathode materials for lithium-ion batteries include lithium nickel cobalt manganese oxides, lithium nickel manganese oxides, lithium cobalt oxides, lithium cobalt aluminum oxides, and lithium iron phosphates. Example anode materials include carbon-lithium, silicon-lithium, tin-lithium, other alloys of lithium, and lithium metal. Example current collector materials include copper and aluminum. Other example rechargeable batteries include sodium-ion, nickel metal hydride, and lead (Pb) absorbent glass mat (AGM) systems. Other example non-rechargeable batteries include primary alkaline or lithium. The term “battery” is used herein to denote both single cell and multiple cell structures.

In some batteries, the electrode/separator stack may be arranged in a roll. In other batteries the electrode/separator stack may be arranged in an accordion-like alternating fold. The term “fold” and the like are used herein to refer to both rolled and accordion-like folded configurations, as well as any other configuration other than a flat sheet. In yet other batteries, separate electrode/separator stacks are layered on one another as flat sheets without folding. To disassemble a lithium-ion battery, the cannister is opened, and the electrode, the current collectors, and the separator materials are recovered. One potential method of opening a battery is to shred the battery in a mechanical shredder. However, shredding can grind the components of the battery together, which may complicate separation of materials for later recycling processes (e.g. relithiation of cathode materials). Shredding also may cause detrimental contamination of the electrode materials.

The risk of contamination of the electrode materials may be reduced by mechanically cutting open the battery, using a saw or a milling machine for example. Mechanical cutting is a more controlled process than shredding, and may reduce the grinding of different materials of the battery together, simplifying separation of the battery materials after opening. However, lithium-ion batteries in a waste stream can be in different states of discharge. Some batteries may be fully charged, some may be partially charged, and some batteries that are considered “discharged” can contain stranded lithium that is still reactive. The unreacted lithium in such batteries poses risks of fire when a battery is opened to recover materials for recycling. Such conditions may pose safety concerns during shredding and mechanical cutting processes. Other types of batteries also may pose various risks when processed in an undischarged state.

Accordingly, examples are disclosed that relate to opening batteries in an end-of-life process using a fluid cutting apparatus. As described in more detail below, the disclosed examples may lessen risks posed by residual battery charge compared to mechanical cutting or shredding methods. Briefly, a stream of a cutting fluid is impinged onto a battery at a sufficient pressure to cut entirely through the battery. Such pressure may help to avoid the cutting fluid from moving laterally into layers of the opened battery, and may reduce an amount of a waste material around a cut generated during the opening process. Further, the cutting fluid may chemically react with electrode materials within the battery to form a passivating layer at the interface created by the cut, which may help to mitigate risks of reactions with active lithium within the electrode materials. Such a method of opening may help to reduce cross-contamination of the recyclable materials compared to shredding. Also, cuts on the battery can be oriented to simplify material recovery. For example, a cut may be oriented to help avoid burdensome unrolling or unfolding of electrode and separator layers of the battery. In some examples, the cutting may be performed under air.

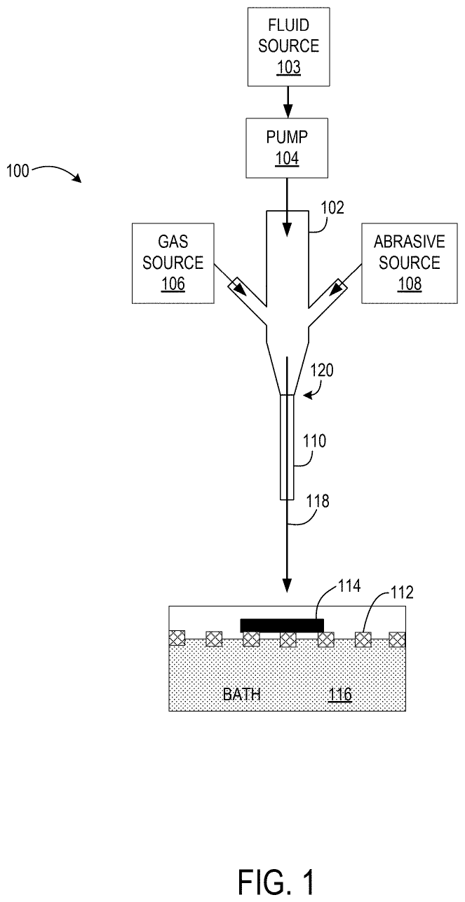

FIG. 1 shows a schematic diagram of an example fluid cutting apparatus 100 that may be used for opening a battery, such as a lithium-ion battery, in an end-of-life process, such as a recycling process. Fluid cutting apparatus 100 comprises a mixing tube 102, a fluid source 103, a pump 104, a gas source 106, an abrasive source 108, an ejection tube 110, a platform 112 on which a battery 114 is placed for cutting (e.g. a mesh or grating in some examples), and a bath 116. In some examples, a battery holder (not shown) may be used to hold a battery during cutting.

Mixing tube 102 is configured to receive and mix together a liquid component with other optional components to form a stream of a cutting fluid 118. Pump 104 is configured to provide a high-pressure liquid component from fluid source 103 to mixing tube 102. Any suitable liquid can be used. Examples include water, carbon dioxide, and ammonia. In some examples, a gas component may be mixed with the liquid component. As such, optional gas source 106 is configured to provide a gas to mixing tube 102 to incorporate into stream of cutting fluid 118. Any suitable gas may be used. Where the liquid component is water, examples of suitable gases include nitrogen, air, carbon dioxide, argon, and helium. An optional abrasive source 108 can be included to provide a granular abrasive to mixing tube 102 for incorporation into stream of cutting fluid 118. Any suitable abrasive material may be used, including a garnet-based abrasive or other mineral-based abrasives. In some examples, the abrasive and/or the gas may be omitted from stream of cutting fluid 118.

The resulting stream of cutting fluid 118 passes through an orifice 120 at one end of mixing tube 102 and into ejection tube 110. Orifice 120 and pump 104 help fluid cutting apparatus 100 form stream of cutting fluid 118 at a sufficient pressure for stream of cutting fluid 118 to cut entirely through battery 114. In some examples, the operating pressure may be in a range of 10,000 to 30,000 pounds-per-square-inch (psi). In other examples, the operating pressure may be in a range of 30,000 to 70,000 psi. In yet other examples, pressures outside of these ranges may be used. The pressure utilized for cutting may be based upon a construction of a battery being cut. For example, higher operating pressures may be used to cut through thicker (in a cutting direction) batteries, as well as to cut through multiple cells at a time, such as cells in a same battery pack. Where multiple cells are arranged along a cutting direction, the use of a relatively higher pressure stream may help to avoid the risk of a partial cut being formed in a cell. A partial cut may cause cutting fluid to flood the layers of the partially cut battery, giving rise to a risk of reaction with unreacted lithium where water is the cutting fluid.

The inventors have found that opening a battery cell using an aqueous cutting fluid stream comprising carbon dioxide as an added gas and a garnet-based abrasive, at sufficient pressure to cut entirely through the battery cell, may mitigate the risk of fire or other hazardous effect of lithium being exposed to air and moisture. Without wishing to be bound by theory, the high-pressure stream utilized impinges electrode materials at an interface of the cut with high energy, causing the rapid formation of a passivating layer of material at the interface of the cut. The passivating layer of material may include lithium carbonate, lithium oxide, and/or other lithium-containing phases that result, for example, from the reaction of unreacted lithium with one or more components of the cutting fluid. The inventors have opened cells having a full state of charge using a stream of cutting fluid comprising water/CO₂/garnet respectively as liquid/gas/abrasive components, under air, without causing fire or thermal runaway, as described in more detail below. Other chemistries than water/CO₂ cutting fluids also may provide such passivating benefits. For example, CO₂ may react with unreacted lithium at the cut interface to form lithium carbonate.

Returning to FIG. 1, platform 112 is configured to position battery 114 above bath 116. This may help to avoid a risk of lithium reactions caused by splashes from bath 116 caused by stream of cutting fluid 118. In other examples, platform 112 may be configured to position battery 114 within bath 116. Such a configuration may be beneficial when battery 114 is fully discharged, as it may help to contain any battery fragments formed during cutting.

In some examples, bath 116 may comprise a dissolved ionic compounded. The use of an ionic solution as bath 116 may help to passivate any unreacted lithium in the battery anode and thereby mitigate the risk of thermal runaway and/or fire. Any suitable concentration of ionic species may be used in bath 116. In some examples, bath 116 may comprise an ionic strength of between 0.2 M (molar) and 8 M. Further, any suitable ionic material can be added to bath 116. Examples include alkali metal salts and polymeric ionomers.

Other materials may be added to bath 116 to adjust cutting conditions. In some examples, a thickener may be added to bath 116. Examples of such thickeners include polyethylene oxide, ethylene glycol, polyvinyl alcohol, and ethylene diamine tetraacetic acid, in neutral form and/or as a polymeric ionomer. Any suitable concentration of such thickeners may be used, including sufficient concentrations to form a gel-like consistency within bath 116. The use of such materials may allow batteries of an unknown charge state to be placed within bath 116 for cutting, as the thickened consistency of the bath may reduce the risk of the liquid within bath 116 (e.g. water) from flowing into a cut battery. Further, the thicker consistency of bath 116 also may help to retain fragments of battery 114 within bath 116, should any such fragments be generated during cutting.

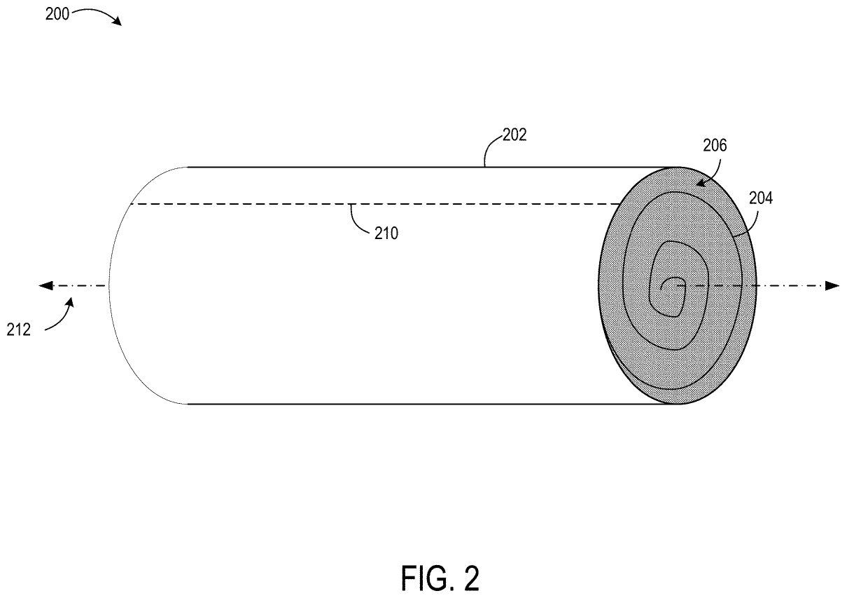

As mentioned previously, a direction and location of one or more cuts on a battery can be arranged to simplify material recovery. Such cuts may be determined based at least upon a configuration of one or more electrode/separator stack layers contained within the battery. FIG. 2 schematically shows an example battery 202 comprising a plurality of insulator layers 204 and a plurality of electrode/separator stack layers, represented collectively at 206. The depicted layers are arranged in a rolled configuration. A cutline 210 is shown extending from a first end of battery 202 to a second end of battery 202, such that cutline 210 is substantially parallel to a folding axis 212. The term “folding axis” indicates a direction along which one or more folds (accordion and/or roll) in an electrode/separator stack extend. Such a configuration may enable plurality of electrode layers 206 to be splayed open after cutting, and thus may avoid burdensome unrolling of the layers. Other cut directions may be used in other examples, such as a cutline that passes transverse to a direction of folding axis 212, including substantially perpendicular to folding axis 212.

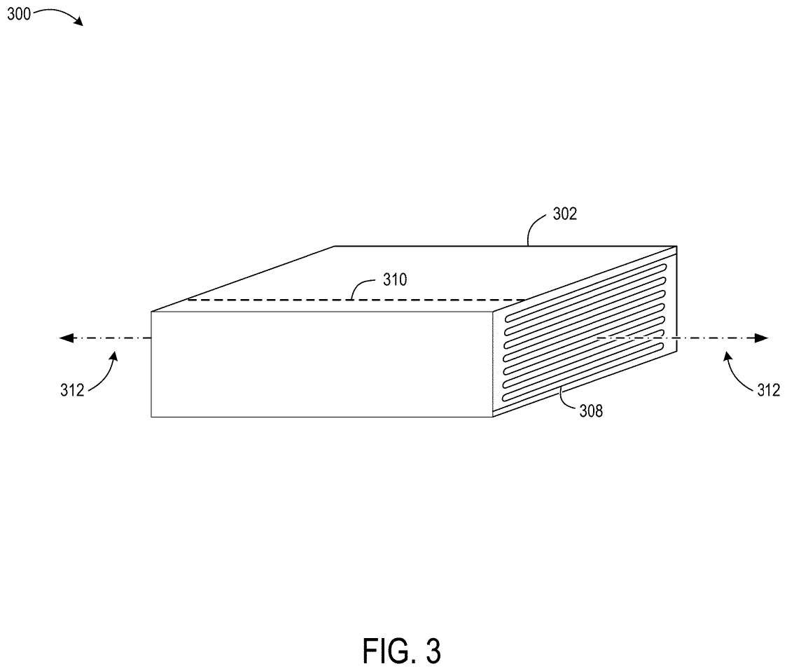

FIG. 3 schematically shows another example battery 302. Battery 302 comprises a stack of layers 308 including anode, separator, cathode and insulator layers arranged in an accordion-like configuration comprising a plurality of alternating folds each along a direction of a folding axis 312. Details of the individual layers within stack of layers 308 are omitted in this schematic view. Similar to cutline 210, a cutline 310 is arranged on battery 302 such that cutline 310 is substantially parallel to folding axis 312. In other examples, other cut directions may be possible, including cuts that are transverse to a direction of folding axis 312, such as a cutline that is substantially perpendicular to folding axis 312.

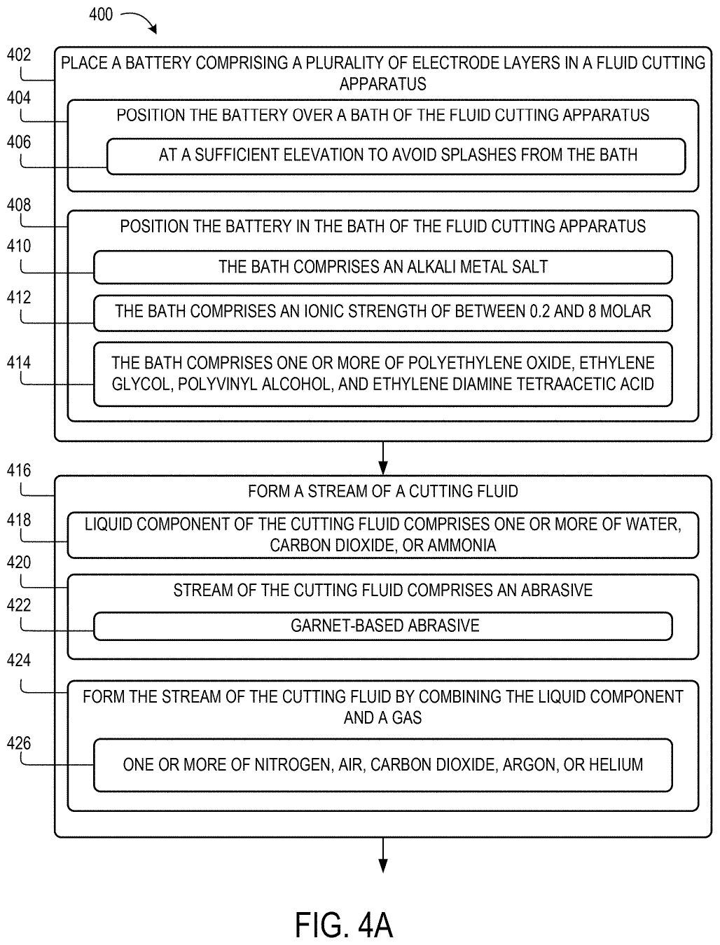

FIG. 4A and FIG. 4B depict a flow diagram of an example method 400 of opening a battery in an end-of-life process. Method 400 may be performed using fluid cutting apparatus 100, for example. Method 400 comprises, at 402, placing a battery comprising a plurality of electrode layers in a fluid cutting apparatus. The battery may have any suitable configuration. For example, the battery may comprise a single cell, or a pack containing multiple cells. Further, each cell may have any suitable electrode/separator arrangement, including a rolled or accordion-like arrangement of electrode/separator layers. The battery may utilize any suitable chemistry, including lithium-ion chemistries.

In some examples, the battery is positioned over a bath of the fluid cutting apparatus during cutting, as indicated at 404 (e.g. supported by a mesh or grated platform). In some such examples, method 400 comprises, at 406, positioning the battery at a sufficient elevation to avoid splashes from the bath. Such an elevation may avoid bath fluid from entering into the battery as the battery is opened. In other examples, method 400 comprises, at 408, positioning the battery in the bath of the fluid cutting apparatus. In such examples, the bath may comprise any suitable composition. For example, the bath may comprise water, with or without additives. In some examples, the bath may comprise an aqueous ionic solution. The use of an ionic solution may help to mitigate the risk of thermal runaway caused by unreacted lithium. Any suitable ionic compound may be added to the bath to form the ionic solution. Examples include alkali metal salts, as indicated at 410, as well as polymeric ionomers. When included, an ionic compound may be included in the bath in any concentration. In some examples, the bath may have an ionic strength of between 0.2 and 8 M, as indicated at 412. The bath alternatively or additionally may comprise a thickener. Examples of suitable thickeners include polyethylene oxide, ethylene glycol, polyvinyl alcohol, and ethylene diamine tetraacetic acid, as indicated at 414. The use of a thickener may help to reduce the splashes, and may help to reduce the risk of the bath fluid from migrating into the battery layers during opening. The thickener may be included in any suitable concentration. In some examples, a sufficient amount of thickener is added to create a gel-like consistency in the bath.

Continuing, method 400 comprises, at 416, forming a stream of a cutting fluid. In some examples, a liquid component of the cutting fluid comprises one or more of water, carbon dioxide, or ammonia, at 418. In other examples, the stream of the cutting fluid comprises an abrasive, such as a granular abrasive, at 420. Any suitable abrasive material may be used, such as a ceramic abrasive. In some such examples, the abrasive may comprise a garnet-based abrasive, as indicated at 422. In other such examples, any other suitable abrasive may be used, including other mineral-based abrasives.

In some examples, method 400 comprises, at 424, forming the stream of the cutting fluid by combining the liquid component and a gas. Any suitable gas may be used. Where the liquid component is water, examples of suitable gases include nitrogen, air, carbon dioxide, argon, and/or helium, at 426. The gas may form a cover layer around the liquid component, and/or may mix with the liquid component.

Method 400 further comprises, at 428, impinging the stream of the cutting fluid onto the battery at a sufficient pressure to cut entirely through all the layers of the battery. Operating the fluid cutting apparatus to impinge the stream of the cutting fluid at a sufficient pressure to avoid the cutting fluid being directed laterally into the layers of the battery (e.g. due to insufficient cutting fluid pressure) may help to reduce the risk of reactions with unreacted lithium within a cut region created by cutting the battery. In some examples, method 400 comprises, at 430, operating the fluid cutting apparatus at an operating pressure in a range of 10,000 to 30,000 psi. In other examples, method 400 comprises, at 432, operating the fluid cutting apparatus at an operating pressure in a range of 30,000 to 70,000 psi, depending upon a battery being cut, as previously discussed. In yet other examples, pressures outside of these ranges above may be used.

As mentioned above, the cutting fluid may form a passivating layer at a battery/air interface formed by cutting the battery, as indicated at 434. For example, where the battery is a lithium-ion battery and the cutting fluid comprises water and/or carbon dioxide, the cutting fluid may react with any unreacted lithium within the cut region to form lithium carbonate, lithium oxide, and/or other lithium compounds that are stable under air or water. The passivating layer can have any suitable thickness.

A cut through the battery may have any suitable orientation. In some examples, the battery is cut along a line from a first end of the battery to a second end of the battery that is substantially parallel to a folding axis of the plurality of the electrode layers, as indicated at 436. As mentioned above, such a configuration may help to simplify material recovery by avoiding burdensome unrolling of the electrode layers. In other examples, the battery may be cut along any other suitable direction.

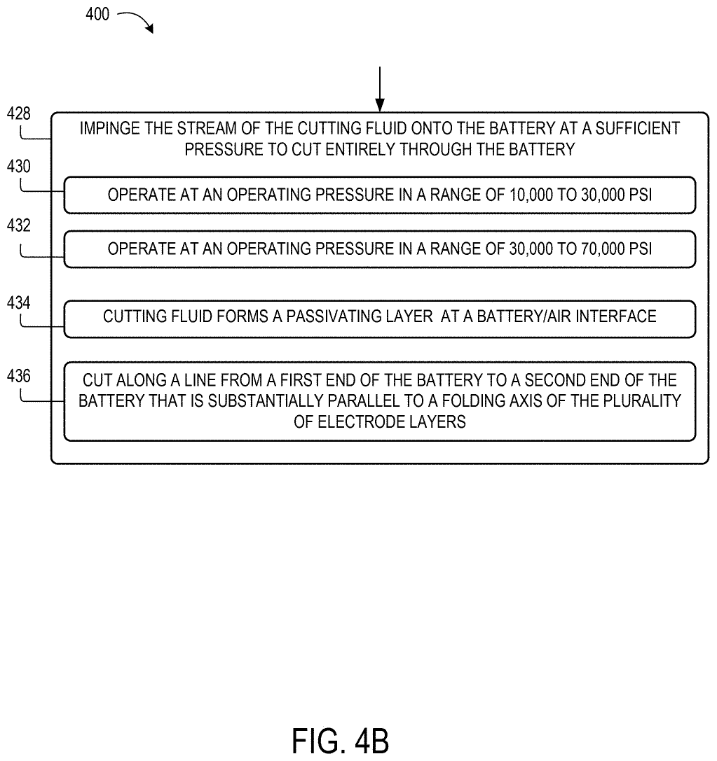

As described in more detail below, the inventors have found that a charged battery may be opened using water as a cutting fluid without causing fire or thermal runaway. As such, opening a charged battery using a fluid cutting apparatus as disclosed herein may allow for recovery of highly pure lithium compounds from an anode of a charged battery with less energy consumption than recovery of lithium compounds from a cathode of a discharged battery. FIG. 5 shows a flow diagram of an example method 500 for recovering lithium from a lithium-ion battery in an end-of-life process. Method 500 comprises, at 502, opening a charged lithium-ion battery using a fluid cutting apparatus, such as fluid cutting apparatus 100 for example. The term “charged” as used herein indicates that the battery is at least partially charged so that recoverable lithium remains in the anode. In some examples, a battery may be charged prior to opening to help maximize an amount of recoverable lithium in the anode.

In some examples, the battery may be cut open using water as a liquid component of a cutting fluid and carbon dioxide as a gaseous component of the cutting fluid, as indicated at 504. In such examples, an abrasive such as a garnet-based abrasive, may be included in the cutting fluid. In other examples, any other suitable cutting fluid may be used, with or without an abrasive. Further, in some such examples, the battery may be cut under air, as indicated at 506. In other examples, the battery may be cut open under any other suitable atmosphere. The use of a water/carbon-dioxide cutting fluid may help to form a passivating layer at interfaces between the air and battery materials formed by cutting the battery. Such passivating layers may reduce risks of thermal runaway and/or fire from exposed unreacted lithium in the battery.

After opening the battery, method 500 may comprises, at 508, deactivating the lithium-ion battery using carbon dioxide. The CO₂ may include some water and/or oxygen in some examples. In some examples, the battery is placed in a chamber that is then filled with pressurized CO₂ gas, as indicated at 510. In other examples, a condensed phase of CO₂, such as supercritical or liquid CO₂, may be used as indicated at 512. The CO₂ may penetrate the battery layers, and convert any unreacted lithium within the battery to lithium oxide. This step both passivates the battery so that electrode materials can be removed from a battery container (e.g. pouch or canister), and also allows the recovery of highly pure lithium in the form of lithium carbonate, which may be separated from the graphitic materials more easily than lithium can be isolated from a cathode material.

Method 500 further comprises, at 514, removing the electrode materials and separator materials, from the battery container. Then, the battery materials are placed in an aqueous solution at 516 to help remove fine lithium carbonate particles from the graphite or other anode material. In some examples, the battery materials may be shredded or ground to help free lithium carbonate from the anode material. Lithium carbonate freed from the anode material may form a suspension of lithium carbonate, which can then be filtered by first using one or more filter steps to separate the lithium carbonate from coarser solids, and then to filter the lithium carbonate from the aqueous solution, as indicated at 518. Any lithium hydroxide formed from the water cutting and/or from the aqueous solution may help to keep the solution at an alkaline pH, which may help to preserve oxidation states of metal ions in a cathode material, and may help to inhibit dissolution, and thus facilitate recycling of the cathode material. The aqueous solution also may be used as a solvent in a later hydrothermal processing of the cathode material to relithiate the cathode, as lithium hydroxide can be used as a lithium source for relithiation. Further, as indicated at 520, other battery materials also may be recovered for recycling. Such materials include anode materials (e.g. graphite), cathode materials, separator materials, and/or current collector materials.

Using method 500, highly pure lithium carbonate may be recovered from a charged battery by cutting the battery under air with a suitable cutting fluid as disclosed, then exposing the battery to carbon dioxide under pressure (whether as a gas or condensed phase) to form lithium carbonate, suspending the lithium carbonate in water, and then filtering. In contrast, recovering lithium from a cathode material such as lithium cobalt aluminum oxide, lithium manganese nickel cobalt oxide, or other complex oxides may require the use of energy-intensive hydrometallurgical methods, with acid dissolutions/extractions, and/or smelting.

In other examples, instead of exposing the cut battery to carbon dioxide as a next process after cutting, the cut battery can be exposed to water, e.g. by immersing in a bath, spraying with water, or in any other suitable manner. The water exposure may convert unreacted lithium in the anode to lithium hydroxide, which dissolves into the water. Then, carbon dioxide can be bubbled through the water (or applied as a gas to a sprayed battery) to convert the lithium hydroxide to lithium carbonate, which precipitates and can be recovered by filtering. Both of the carbon dioxide passivation process and the water/carbon dioxide carbonate formation process have the additional benefit of capturing carbon dioxide.

### EXPERIMENTAL RESULTS

Lithium-ion batteries comprising stacked (not folded) layers of lithium nickel manganese cobalt oxide cathodes and lithium-intercalated graphite anodes were cut by fluidic jet cutting, via a fluid cutting apparatus, using a water/carbon dioxide/garnet as liquid/gas/abrasive cutting fluid. The batteries were cut open in a full state of charge under air. No significant temperature increase was observed during or after the cutting. Likewise, no reaction of lithium with water was observed. The cut batteries were stable in air after cutting open. A white layer was visible at the battery/air interface after cutting.

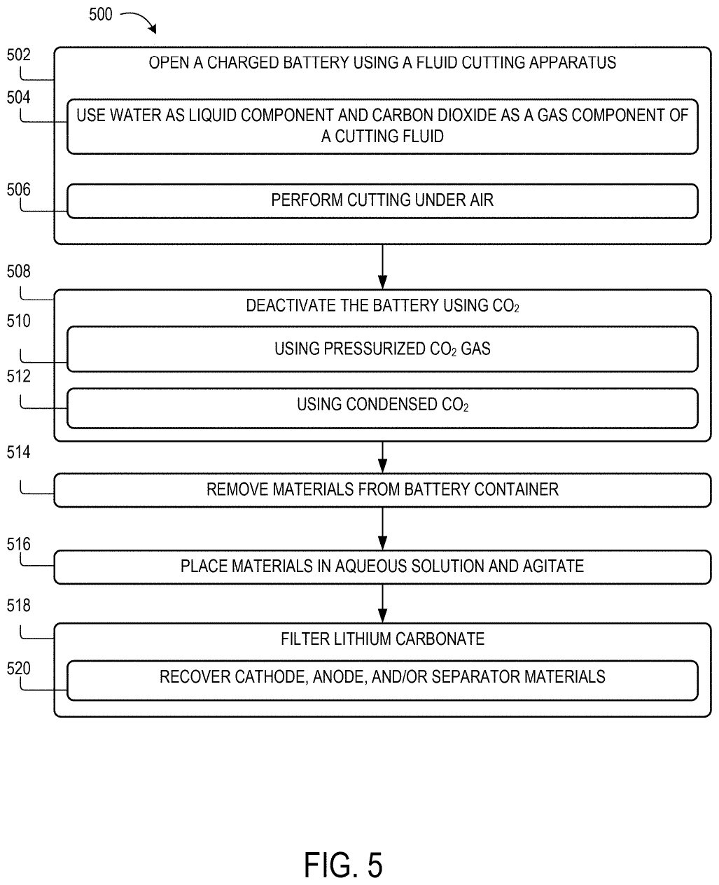

Next, After the batteries were cut, the batteries were placed in a glove box under argon, and an anode layer was exposed. FIG. 6 shows an example battery 600 that was cut within the splashing range of a cutting bath. Battery 600 experienced some loss of active lithium material, as copper 602 from a current collector can be seen where in some areas the anode material delaminated from a copper current collector. Further, the color of the graphitic anode had a blueish hue, indicating some reaction of the lithium with the splashed water. A passivating layer 604 can be seen as white along the cut edges.

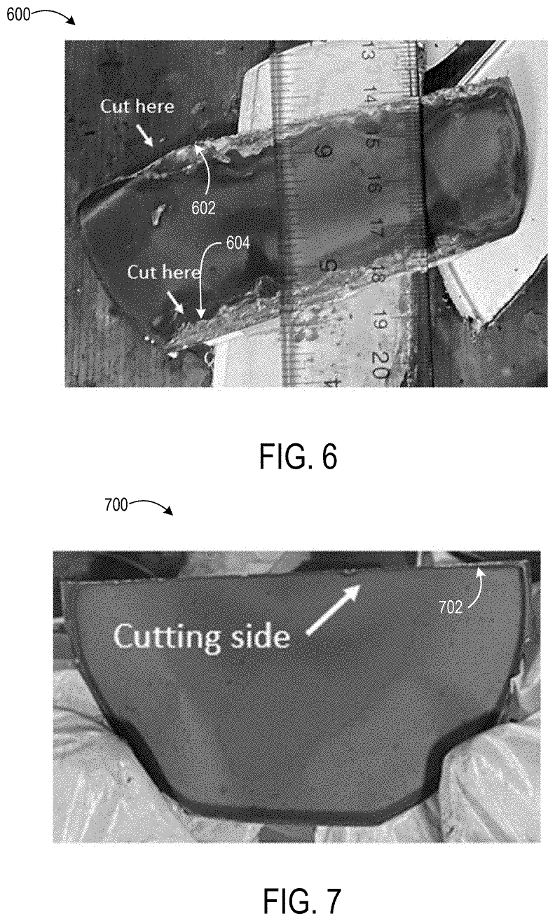

FIG. 7 shows an example battery 700 that was cut while it was positioned above a splashing range of the cutting bath. The anode material of battery 700 has a gold color typical of lithium-intercalated graphite. Further, a thin passivating layer 702, on the order of 20,000 angstroms, was formed at the cut edge of battery 700. From the gold color of the anode, the passivating layer can be seen to have protected the anode from the air after cutting.

It will be understood that the configurations and/or approaches described herein are exemplary in nature, and that these specific embodiments or examples are not to be considered in a limiting sense, because numerous variations are possible. This disclosure also includes all novel and non-obvious combinations and sub-combinations of the above articles, systems, configurations, methods, and other features, functions, acts, and/or properties disclosed herein, as well as any and all equivalents thereof.

The specific processes described herein may represent one or more of any number of strategies. Some of the process steps described and/or illustrated herein may, in some embodiments, be omitted without departing from the scope of this disclosure, and/or additional steps may be used. Likewise, the indicated sequence of the process steps may not always be required to achieve the intended results, but is provided for ease of illustration and description. One or more of the illustrated actions, functions, or operations may be performed repeatedly, depending on the particular strategy being used.

1. A method of opening a battery in an end-of-life process, the battery comprising a plurality of electrode layers, the method comprising:
placing the battery in a fluid cutting apparatus;
forming a stream of a cutting fluid; and
impinging the stream of the cutting fluid onto the battery at a sufficient pressure to form a cut entirely through all layers of the battery, wherein the cutting fluid forms a passivating layer at an interface formed by the cut by reacting with one or more electrode materials within the battery.

2. The method of claim 1, wherein impinging the stream of the cutting fluid onto the battery comprises operating the fluid cutting apparatus at an operating pressure in a range of 10,000 to 30,000 pounds per square inch.

3. The method of claim 1, wherein impinging the stream of the cutting fluid onto the battery comprises operating the fluid cutting apparatus at an operating pressure in a range of 30,000 to 70,000 pounds per square inch.

4. The method of claim 1, further comprising positioning the battery over a bath of the fluid cutting apparatus at a sufficient elevation to avoid splashes from the bath caused by the cutting fluid.

5. The method of claim 1, further comprising positioning the battery in a bath of the fluid cutting apparatus.

6. The method of claim 5, wherein the bath comprises an ionic strength of between 0.2M and 8M.

7. The method of claim 5, wherein the bath comprises an alkali metal salt.

8. The method of claim 5, wherein the bath comprises one or more of polyethylene oxide, ethylene glycol, polyvinyl alcohol, and ethylene diamine tetraacetic acid.

9. The method of claim 1, wherein the stream of the cutting fluid comprises an abrasive.

10. The method of claim 1, wherein forming the stream of the cutting fluid comprises combining a liquid component and a gas.

11. The method of claim 10, wherein the liquid component of the cutting fluid comprises one or more of water, carbon dioxide, or ammonia.

12. The method of claim 10, wherein the gas comprises one or more of nitrogen, air, carbon dioxide, argon, or helium.

13. The method of claim 1, wherein impinging the stream of the cutting fluid onto the battery comprises cutting the battery along a line from a first end of the battery to a second end of the battery.

14. A method of opening a lithium-ion battery in an end-of-life process, the method comprising:
positioning the battery over a bath of a fluid cutting apparatus;
forming a stream of a cutting fluid; and
impinging the stream of the cutting fluid onto the battery at a sufficient pressure to form a cut entirely through the battery, wherein the battery is positioned at a sufficient elevation above the bath of the fluid cutting apparatus to avoid splashes from the bath during cutting.

15. The method of claim 14, wherein forming the stream of the cutting fluid comprises combining a liquid component and a gas, and wherein the cutting fluid forms a passivating layer at an interface formed by the cut by reacting with one or more electrode materials within the battery.

16. The method of claim 14, wherein the gas comprises one or more of nitrogen, air, carbon dioxide, argon, or helium.

17. The method of claim 14, wherein the stream of the cutting fluid comprises an abrasive.

18. A method of forming a passivating layer on a lithium-containing component of a lithium-ion battery during a battery opening process, the method comprising:
forming a stream of a cutting fluid by combining a liquid component and a gas; and
impinging the stream of the cutting fluid onto the lithium-containing component of the lithium-ion battery such that the stream of the cutting fluid forms the passivating layer by reacting with the lithium-containing component.

19. The method of claim 18, wherein the lithium-containing component comprises one or more of lithium, carbon-lithium, silicon-lithium, tin-lithium, or another alloy of lithium.

20. The method of claim 18, wherein the liquid component of the cutting fluid comprises one or more of water, carbon dioxide, or ammonia.
